(19) United States
(12) Patent Application Publication
(10) Pub. No.: US 2013/0289970 A1
(43) Pub. Date: Oct. 31, 2013

(54) Global Touch Language as Cross Translation Between Languages

(71) Applicant: Raanan Liebermann, North Haven, CT (US)

(72) Inventor: Raanan Liebermann, North Haven, CT (US)

(21) Appl. No.: 13/348,796

(22) Filed: Jan. 12, 2012

Related U.S. Application Data
(63) Continuation-in-part of application No. 10/718,023, filed on Nov. 19, 2003, now Pat. No. 8,523,572.

(51) Int. Cl. G06F 17/28

(52) U.S. Cl. CPC G06F 17/28
USPC 704/2

(57) ABSTRACT

A translation system is provided, enabling translation from one language to another language, and/or translation between any two or more languages by utilizing a focal core of a conceptual language that is independent of vocabulary and syntax and presented in the embodiment of Touch Language.

### CROSS REFERENCE TO RELATED APPLICATION(S)

This application is a continuation-in-part of U.S. patent application Ser. No. 10/718,023, filed Nov. 19, 2003 entitled “TOUCH LANGUAGE”. This application makes further use of elements from a U.S. patent application Ser. No. 10/219,630, filed Aug. 14, 2002, now U.S. Pat. No. 7,774,194, entitled “METHOD AND APPARATUS FOR SEAMLESS TRANSITION OF VOICE AND/OR TEXT INTO SIGN LANGUAGE”.

### BACKGROUND

1. Field of the Invention

The present invention relates to cross translation(s) among languages, utilizing Touch Language as one embodiment of concept articulation for at least one central conversion facility(s). It is further augmented by content interpretation based on previously developed technology utilized in translations of text to sign language.

2. Prior Art

Various forms and algorithms exist for translating from one language to another. However, such translations are language dependent and are suitable only for translations between one language and another, lacking the ability of being universal in nature. Further, said translations are grammar dependent. Global Touch Language is different, utilizing a conceptual language, the Touch Languages, as a focal intermediary step between the languages due to its concept based structure.

### SUMMARY OF THE INVENTION

Touch Language^{[1]} was developed as language based on concepts rather than verbs, syntax and grammar for the benefit of persons who are either blind or deaf and blind. The interface to the target group utilizes activating a button for Morse code for expressions and vibrations and pecking on hand and palms for reception. The language, stripped of the mechanical interfaces to the person has additional attributes making it an ideal communication vehicle among various dialects of Sign Languages, such as American Sign Language, (ASL); English Sign Language (ESL); or British Sign Language (BSL), let alone other non-English based languages. Furthermore, Touch Language with the added verb translation segment encapsulates a communication apparatus for persons of different languages who do not speak each other's language, without the need for traditional translation algorithms.

Namely, translation from one language to another can be done without any knowledge of the other language and utilizing Touch Language as the go between because Touch language is not a textual language but rather a conceptual language that is the same for all and cuts across languages and cultures. This is specifically useful for online translation between languages, or when using texting and other applications on mobile communication devices. Namely, language A is translated to Touch Language and Touch Language is translated into Language B. The reason for the trilateral translation need is due to the fact that Touch Language is universal and is based on concepts and therefore operates across languages.

Certain modifications to Touch Language are needed when it is utilized for such text translation because in Touch Language we differentiate between such elements as characters of persons or gender and when the text is not explicit, an added factor is required to be added during the translation. For example, let us take the following sentence: “an older man is chasing a young woman who runs away from him”. Touch Language would involve three pecks (called “nibbles” in Touch Language) on the back of the index finger and a single nibble on the back of the little finger. However, the text at that point did not specify the man as being “bad” and the young woman as being “good”, while the mere selection of the first and little finger in Touch Language already proclaim the gender and character of the protagonists. Therefore, we add with the translation the thumb following the index finger to “neutralize” any assumptions on the character of the man.

Likewise, the thumb would follow the little finger to neutralize any assumptions of “good” related to the woman. Notice that the fingers, first the index then the little finger already carry an assumption and therefore the neutralization is required. We could have as easily utilized the ring finger for the man, meaning a “good” man and the and the fourth finger for the woman, meaning “bad” woman, then proceed to “neutralize” each one of them by adding the thumb as an immediate follow up to the finger identifying the person and gender.

Further, to ascertain the connectivity between the fingers and the thumb immediately following each of them, in one embodiment, the nibbles are provided only on the following thumb and not the preceding finger establishing the gender. The nibbles on the thumb further contribute to perceiving the thumb and the finger preceding it as a single unit for describing the individual and his or her age. Namely, the nibbles destined for the specific finger, skip that finger and are provided only on the following thumb.

There are other additional considerations of importance when handling cross translations between languages. Consider idioms. The textual material itself is useless for translation of concepts and we need to consider other elements. We take our cue from earlier work in the field (Liebermann at al. 2002), directing us to scan each sentence for identifying idioms related to the specific case in hand. The procedure entails comparing the text with a list of idioms residing in the database of the specific language being the source for the translation. Such search and identification is part of the translation algorithm. Such elements are intrinsic to the unique challenges of cross translations between textual and conceptual languages and are added to the basic trilateral translations, where Touch Language is central core linking the protagonist languages.

In accordance with the instant disclosure, there is described a translation system utilizing Touch Language, comprising language based on concepts for translation of content among languages.

Other details of the translation system of the present invention, as well as other objects and advantages attended thereto are set forth in the following detailed description and the accompanying drawings, where like reference numerals depict like elements.

### BRIEF DESCRIPTION OF THE DRAWINGS

FIG. 1 illustrates the translation principle

FIG. 2 illustrates the translation process

FIG. 3 illustrates verb translation preliminaries

FIG. 4 illustrates content interpretation and Delivery.

### DETAILED DESCRIPTION OF THE PREFERRED EMBODIMENT(S)

The Translation Process

The complete translation process encompasses three steps, where two involve translations to and from Touch language and a third step of handling idioms, verbs, and other idiosyncratic words pertaining to specific articulations, such as professions and specific vocabulary utilized thereof for translation between the two languages, which we all group for convenience under “Verb(s)”. The verb translation is a direct one-to-one identification of the counter-verb in the database of the two languages that is basically cross translation between two “look-up” tables. As will be noticed, there is no identification of the languages involved unless decreed by the user. The reason for it is that the system assumes each user to work in his or her own language and therefore said users have in the database housed on the device utilized, such as a computer or mobile communication device, a database containing a list of verbs in the user's language. The databases of list of verbs (including idiosyncratic words in languages) may be downloaded by the user when subscribing to the translations service or buying the product. Upon connection of a party to another using a different language, the two respective applications residing on each party's electronic unit, exchange identification of their respective language, thereby enabling a simple one-to-one translation of the verbs relevant to each language. The translation between the verbs can either be done on the designated website for translation, or directly on each electronic unit to which the appropriate counterpart verb list database was downloaded at the beginning of the translation process.

When a person is in another country with no knowledge or sufficient knowledge of that country's language, said person can preload said country's verb list to enable rapid translation utilizing a mobile device containing an appropriate application (so called “App”) for the translation algorithm disclosed herein. The appropriate verbs lookup table for said person's own language would have already resided in said mobile device or can similarly be downloaded.

We next discuss Touch Language as Global Communication Tool Traversing Languages. As articulated above, Touch Language can be extended as a functional communication tool among individuals of different cultures and languages, enabling the sharing of ideas and communicating directly without the need to know the other parties' languages. Such extension, that we term as either Global Touch Language (GTL) or International Touch Language (ITL), does not need the special gloves utilized by blind persons for communicating in Touch Language and functional equivalent symbols are utilized instead. The symbols do not rely on any specific language or its alphabet and are universal. Apart from the symbols conveying the articulation provided by the functional equivalents to gloves, the Global Touch Language core is identical to Touch Language. The symbols are easily represented on a keyboard for easy transmission and reception as is disclosed below. Such symbols may be of geometric forms that may be represented by identifying characters and/or numerals, or may be a direct numeral representation of the GTL (or ITL) core. Each such representation is presented below.

Thus, the hands, fingers, tapping and orientations of Touch Language are provided below in their symbolic format and reduction to forms amenable for automated processing. The geometric representation is disclosed first, followed by the numerical representation.

The Fingers

Each finger has three segments to it, divided by the three phalanges, except the thumb with only two segment and two phalanges. Each of the segments is symbolized by a triangle in the Global Touch Language. A line running parallel to the base of the triangle indicates the location of each segment on a finger. Thus the first segment right behind the nail has a single line under the base of the triangle, the second segment has two such parallel lines and the third segment being closest to the hand has three such parallel lines. Each finger is identified by its location on the hand, where the thumb is number one and the little finger is number 5. The numbers identifying the finger appear at the top of any triangle represented, irrespective if it is above a base or a tip of the triangle.

Since each finger has an inner part and an outer part that is the backside of the finger, Global Touch Language distinguishes between them according to the triangle position. A triangle with a base at the lower part represents the back of the finger segment, while a triangle that appears to stand on its head with the wide base at the top, represents the inner segment of a finger.

The Nibbles

The number of nibbles impacting any finger segment appears as a number that is either embedded inside the triangle or appears on the outside of the triangle at its bottom, irrespective of whether the bottom of the triangle is the base or the tip of the triangle.

The Hands

The hand is represented by a square. Its palm is represented by a square that has an inner line drawn vertically inside it and just above its base. The back of the hand is represented by a parallel line inside the square that is just underneath its upper side, i.e., it's ceiling.

Orientation

The palm and the back of the hand are each represented as a square, with a parallel line running next to one of its vertical sides. The one on the right side represents the right hand and the one on the left side represents the left hand. The triangles utilize the same convention for right and left as the palm and the back of the hand. Namely, the triangles are depicted with a short vertical line attached to one side of the wide base indicating right and left hand finger. Specifically, a vertical line that is perpendicular to one side of the base of any triangle that may have the length of a fraction of the length of the triangle's side represents the intuitive respective right or left side of the triangle and thus the palm.

The Verbs

Verbs are the only component in Touch Language that rely on the specific cultural and language attribute of a specific language and are coded and transmitted in the case of the blind and deafblind utilizing Morse code but may be transmitted in any form suitable for the translation process, such as electronic transmission. Handling verbs in Touch Language (TL) and Global Touch Language (GTL) or (ITL) is quite similar and utilizing it in communications requires translation from one language to another. However, such translation is greatly simplified when utilizing the process of lookup tables. Namely, we house for each language an alphabetized list of verbs; each individual utilizing GTL has his or her native language identifier coded into the transmission and reception, enabling an automatic comparison between two relevant and respective lookup tables. The languages appear by name in an alphabetized list and their physical location in the list is numerically recognized. Such numerals may be built from any acceptable list, such as the ISO 639, or adopting the ISO 639 as the set of international standards that already contains short codes for names of languages. The recognized numerals are sent at the beginning of each transmission and may be delineated by proper delimiters such as square brackets. For example Amharic is denoted using ISO 639 by “28”, while Arabic is denoted by “39”. Sending a communication in Amharic to a person receiving it in Arabic would leave the sender with “[28]” at the beginning of the transmission and a table lookup between the “28” and “39” would deliver the proper verb to the individual speaking Arabic whose material is sent out with “[39]” at the beginning of the sentence. Variations on such principle are possible as long as they are consistent globally for all users of Global Touch Language. However, we need briefly to visit verbs in Touch Language to realize that we need to utilize two different sets of verbs depending on whether one of the parties is blind or deafblind, which we discuss next.

Verbs in Touch Language

We discussed the communication of verbs in Touch Language where the verbs are spelled utilizing the Morse code. One of the goals of Touch Language is to be a useful cross languages and cultures tool. Therefore, in order to ascertain that Touch Language is completely transparent to language we introduce the inherent Touch Language structure for verbs. Deaf persons who use sign language do not need to be familiar with the 70,000 plus words that one can find in an English dictionary. Instead, they utilize signs that correspond to an approximate subset of some 2,500 to 3,500 words. Such economy in signs is achieved at the cost of relinquishing some fine grain detail and nuances of words, where a particular word can describe several elements. For example, happy, merry, and gay, all share the same sign. Likewise, buy and purchase; obtain and get share a sign; or walk and go; as well as see and view. Each of the mentioned groups shares the same sign within the group.

The reverse, where particular words have multiple meanings does not pose a problem in sign language since the potential for confusion is averted, as every meaning has a different sign associated with it. Namely, a word like “cool” is signed differently for cool temperature and as for a person considered being cool.

Touch Language accords us further economy in articulating verbs. For example, if a small animal is a protagonist in a description, we will give up the distinction whether such small animal is a “dog”, “cat”, or “rabbit”. The impetus for such cavalier handling of the specifics of such a small animal results from the assumption that a congenital deafblind person has never seen a dog or a cat and therefore giving up such articulation is not too heavy of a price to pay. Late blind persons who have seen such animals would certainly realize the lost articulation and would be more cognizant of the price paid; yet the result would be the same. Likewise, if an assault instrument is a knife, sword, pistol or rifle is of less importance than the notion of it being an assault instrument. Such and similar economy drastically reduces the number of verbs needed to be part of the Touch Language bank of verbs. However, when utilizing verbs for GTL we have to distinguish if the translation involves a blind or deafblind person or a hearing and seeing person so that the appropriate mode of translation is provided

Time Vector

Time element expressed in tense of grammar distinguishes between past, present and future and in some sophisticated languages, such as English a non-discrete continuation of time is provided as well. The time element in Global Touch Language is provided by a symbol that may be a numeral, such as 7. In such representation the following time element may take the following form:

### Present=7

### Past=−7

### Future=+7

Continuous present=77 (777 for extended duration)

### Continuous Past=−77

Continuous future=+77
However, in the alternative representation described below, we forego the continuous tense altogether and provide a single digit for the time element, with the time vector pointing to the right. Namely:

### Past=700

### Present=070

### Future=007

Alternative Representation

An alternative representation, suitable for mechanical and/or electronic translation utilizes at least one of numerals and letter characters, though pure numeral combination is preferable due to the fact of different character styles in various languages. Under the alternative representation numerals are assigned to the articulations as appeared in the configurations of the geometric representation discussed earlier. In the preferred embodiment, such representation may appear as follows:

Each transmitted symbol of Touch Language (TL) concept is contained in a fixed ten-segment group containing three numerals per group to a total of 30 numerals, with a potential parity check (odd or even) that may be added to the group as an eleventh segment. Not all ten segments contain information at any given time Nonetheless, they are not eliminated but appear in the group with a designation of no information carried, such as being a full null segment that may be a “000”, thereby maintaining the integrity of the transmission. Standard techniques such as parity are maintained as well. The time segment, articulating the tense precedes all segments.

The segments always represent the following structure: [Time vector] [Character declaration] [Hand declaration] [Which hand] [Hand orientation] [Fingers declaration] [Specific fingers involved] [Nibbles declaration] [Number of Nibbles] [Verb] ([Possible Parity check])

The specific hand and finger representation may be as follows:

### Right=10

### Left=20

### Upper=30

### Lower=40

### Hand 90

### Fingers 80

### Nibbles=50

Number of nibbles=1, . . . , n
First finger=1

### Second Finger=2

### Third Finger=3

Fourth finger=4
Fifth finger=5

All description elements come in blocks of thee to a total of 33 digits. Thus any description has the representation of: 000.000.000.000.000.000.000.000.000.000.(000) Examples (excluding parity bit):

Right hand upper side; first finger; three nibbles=000.000.000.010.030.080.001.050.003.000
Note that the “000” at the “hand location” indicates that the hand is not involved, while the “080” group indicates that the fingers are. Likewise, the time segment being the first segment indicates no time relation and the second (“character”) segment indicates no specific character neutralizing provided by the thumb, neither is there a numeral indicating what verb needs to be looked up in the lookup table.

When the example given relates to specific concept, it looks quite similar. Namely,

An “older bad man (no characteristics neutralizing of personality) walked” would appear as:
700.000.000.010.030.080.001.050.003.333, where “333” simulates the location of the verb “walk”.
In actuality, there is no need for the points delimiters and the numerals may be provided in a continuous series of numerals.

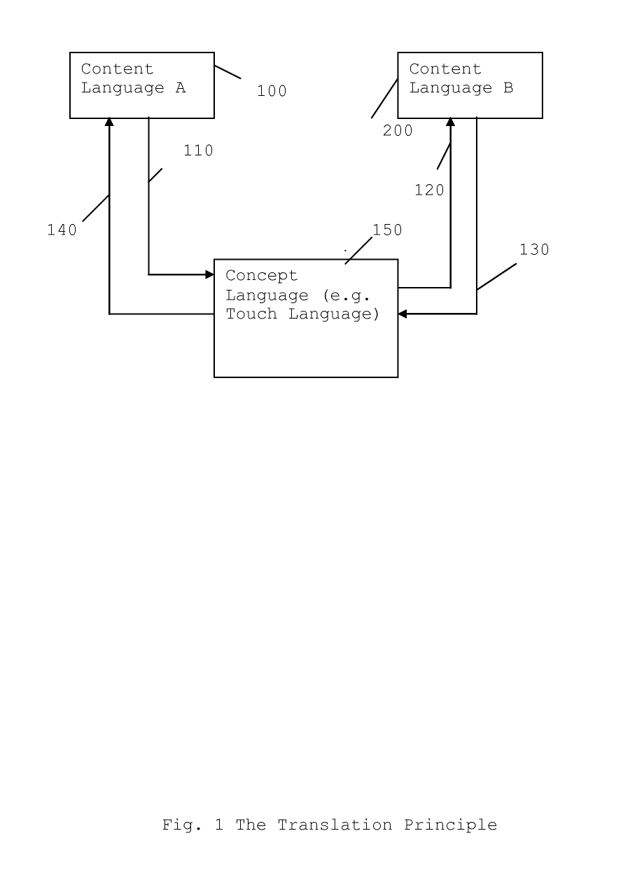

Referring now to FIG. 1, we note the general principle of the translation system, where language A in (100) is connected in (110) with the Touch language engine in (150) and after the content is changed there to language B it returns via (120) to the person utilizing Language B in (200). Conversely, the person utilizing language B has the language connect via (130) with the Touch Language core in (150), where it undergoes the changes resulting in its presentation in Language A and provided to the person using language A in (100) via (140).

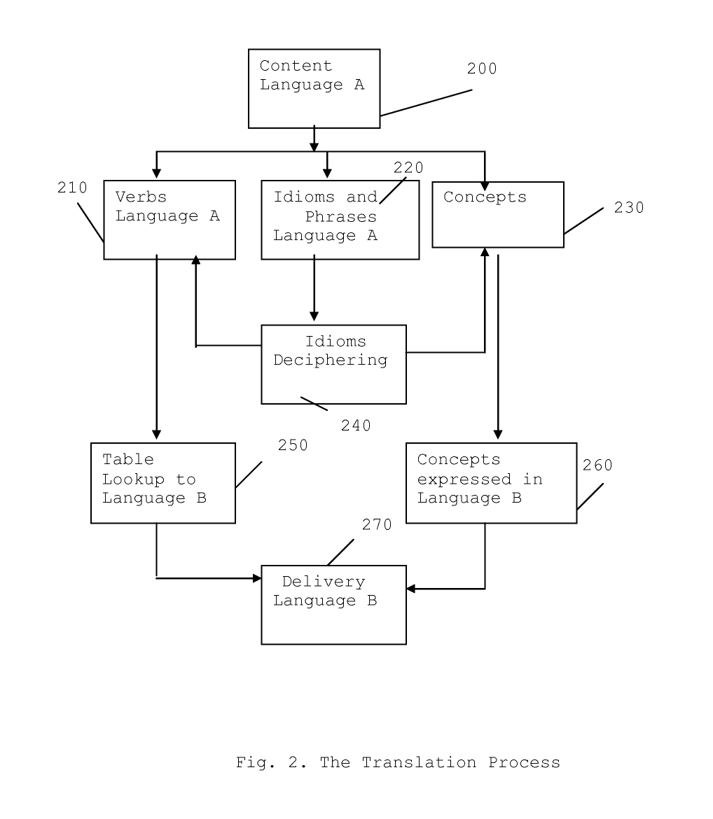

FIG. 2 illustrates the translation process. The content in language A in (200) is partitioned to verbs in (210), to idioms and/or phrases in (220) and concepts in (230). The idioms from (220) are deciphered in (240) and returned either as verbs (or the language idiosyncratic words) to (210) and/or as concepts to (230). The concepts in (230) are expressed in language B in (260) and move to delivery in (270), while the verbs move to the lookup table in (250) and emerge as verbs (and/or the idiosyncratic words) in language B that then move to the delivery in (270).

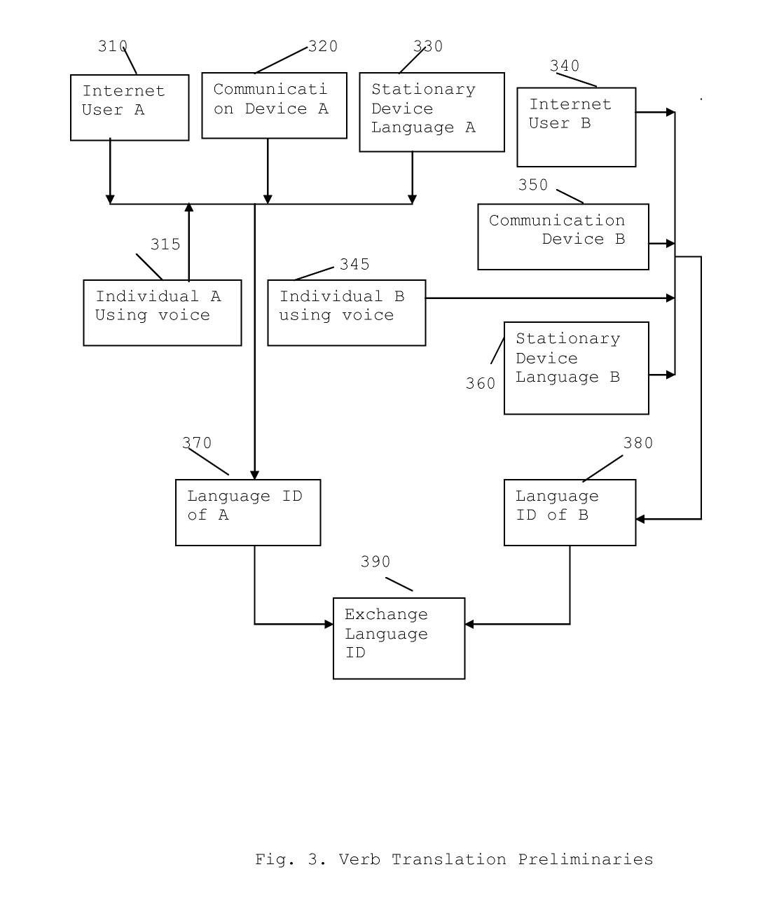

FIG. 3 illustrates the preliminaries for verbs translations utilizing the lookup tables. Verbs may come in language A from the Internet in (310); from an individual utilizing voice in (315); from a communication device in (320); or from a stationary device in (330), such as a TV, theater, lecture hall or the UN Assembly, to name a few. Said language A receives the appropriate language ID in (370). Similarly, language B may come from the Internet in (340); from an individual using voice in (345); from a communication device in (350); or from a stationary device in (360), such as described for the other language. Said language B receives the appropriate language ID in (380) and proceeds to exchange the language ID with language A ID in (390). Similarly, the language ID in (370) undergoes language exchange in (390).

It should be noted that the “voice” of the individual in (315) and (345) stands also for disabled individuals who may use sign language or any tactile form of communication.

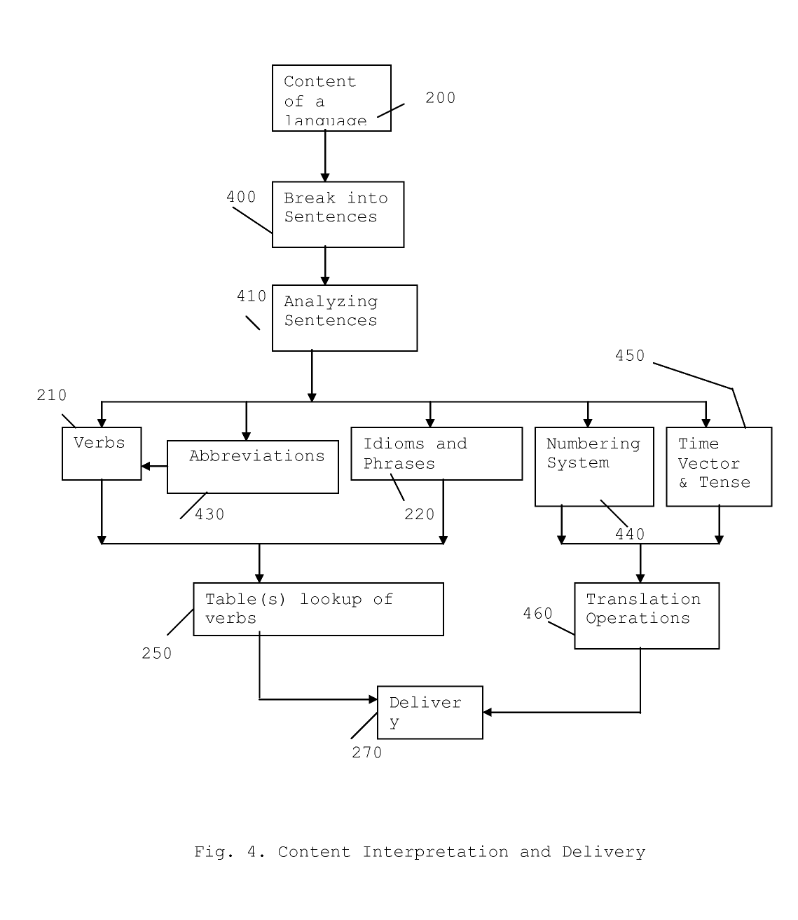

FIG. 4 illustrates content interpretation and delivery in the counterpart language. The process is mostly hinging on previously developed technology by Liebermann at al. in now U.S. Pat. No. 7,774,194. The content of language A in (200) undergoes segmentation by breaking it up into sentences in (400) and the individual sentences are analyzed in (410). The result of the analysis may provide such elements as verbs in (210), idioms or phrases in (220), abbreviations in (430), numbering system in (440) and tense indicating a time vector in (450). The abbreviations in (430) are deciphered utilizing a lookup table for them and added to the list of verbs in (210). The verbs in (210) and the idioms and phrases in (220) are then sent to the table lookup in (250). The numbering system in (440) and the time vector and tense in (450) end up in the translation operations in (460). Finally, both translation operations in (460) and the conversions from the table lookup in (250) are moved to delivery in (270).

As can be seen from the foregoing description, a global translation system enabling translations between languages utilizing a core of conceptual language has been provided. While the present invention has been described in the context of specific embodiment(s) thereof, other alternatives, modifications, and variations may become apparent to those skilled in the art having read the foregoing description. Accordingly, it is intended to embrace those alternatives, modifications, and variations.

What is claimed is:

1. A method for translating content between at least two languages comprising conceptual language as intermediary step between said languages.

2. The method in accordance with claim 1, wherein said conceptual language is Touch Language.

3. The method in accordance with claim 1, wherein content in one language is translated to at least one segment of said conceptual language and then said content is translated from said at least one segment of said conceptual language into another language.

4. The method in accordance with claim 1, wherein said translation comprises usage of at least one of a processing unit, computer, video, Internet, communication device(s), mobile device(s), movie apparatus, theater apparatus and a stationary device(s).

5. The method in accordance with claim 1, wherein said translation comprises communication between at least one of a individual and a device, and at least two individuals.

6. The method in accordance with claim 3, wherein said translation comprises translating at least one of a text, voice, tactile information, and sign language from one language into another language.

7. A system for translating content(s) between at least two languages comprising means for interfacing with a conceptual language system for translating said content into a conceptual language and means for then translating said translated content in said conceptual language into another language.

8. The system in accordance with claim 7, wherein said means for interfacing with said conceptual language comprise means for said interfacing to include interfacing with Touch Language for translating said content into Touch language; said interfacing further comprising means for then translating said translated content in Touch Language into a content of another language

9. The system in accordance with claim 6, wherein said conceptual language system comprises means for providing content in conceptual form; said means comprising at least one of a body part(s), at least one simulated body part(s), and at least one of a performing action(s), simulating said performing action(s) on said body part(s), or simulated body part(s) for the purpose of articulating said content, and at least one program(s) to perform said provision.

10. The system in accordance with claim 6, wherein said means comprising means for at least one of a transmitting and receiving data for translating content to at least one of a to a conceptual language and from said conceptual language; said means further comprise processing means comprising at least one of a processor, memory, and software for processing said data; said data comprising content in at least one language(s).

11. The system in accordance with claim 7, wherein said at least one of a transmitting and receiving of said data comprises means for transmitting said content in at least one of a voice, text, video, and tactile form comprising a device and receiving said content in at least one of a hearing, seeing, tactile form; said means further comprise a device for enabling said receiving and transmitting.

12. The system in accordance with claim 9, wherein said device comprises means for at least one of a receiving and transmitting data comprising at least one of a transducer, processor, memory, software and transmitting and receiving protocol.

13. The system in accordance with claim 9, wherein said device further comprises at least one of a TV, a computing device, a computer, a video, a public addressing system, movie accessory apparatus, theater accessory apparatus, and a mobile communication apparatus for at least one of a transmitting content in the language utilized by an individual and receiving content in another language of at least one of said individual and another individual.
